(19) United States
(12) Patent Application Publication
(10) Pub. No.: US 2012/0034429 A1
(43) Pub. Date: Feb. 9, 2012

(54) ADAPTIVE DISRUPTIVE ENVIRONMENTAL GRAPHIC DESIGN CLASS PATTERN AND METHODS RELATED THERETO

(75) Inventor: Matthew E. Pettingill, Overland Park, KS (US)

(73) Assignee: Gregory M. Pettingill, Kansas City, MO (US)

(21) Appl. No.: 13/197,722

(22) Filed: Aug. 3, 2011

Related U.S. Application Data
(60) Provisional application No. 61/370,253, filed on Aug. 3, 2010.

(51) Int. Cl. B32B 3/10; G06K 9/00

(52) U.S. Cl. 428/195.1; 382/100

(57) ABSTRACT

A picture, or graphic design, that defines a new, hybrid pattern-class, and that is a representative formation of design pixels into a complex new type of digital pattern with at least three basic and functional layers, and with targeted enhancements for texture and dimensionality, wherein lighter colors “float” on top of the pattern while the dark colors “sink to the bottom” of the pattern below the main color layers.

### CROSS-REFERENCE AND PRIORITY CLAIM TO RELATED APPLICATION

To the fullest extent permitted by law, the present U.S. Non-Provisional Patent Application claims priority to and the benefit of United States Provisional Patent Application entitled “Adaptive Disruptive Environmental Graphic Design Class Pattern and Methods Related Thereto,” filed on Aug. 3, 2010, on behalf of inventor Matthew E. Pettingill, and having assigned Ser. No. 61/370,253, wherein the referenced application is incorporated by reference herein.

### FIELD

The present disclosure relates generally to graphic design, and more particularly, to an adaptive disruptive environmental graphic design class pattern and methods related thereto.

### BACKGROUND

Numerous patterns are known for use in camouflage, wherein it is a common intent of camouflage to merge with surroundings by disrupting outlines. Various methods and pattern designs have approached the problem from various perspectives. One well-known pattern is Disruptive Pattern Material (DPM). Another is Engineer Research & Development Laboratory (ERDL) Leaf pattern, which is a four colored pattern. Still another is the six color Desert Battle Dress Uniform (DBDU). More recently, multilayer digital camouflage (digicam) has become known, cloaking objects with pixilated camouflage, wherein small micropatterns function to blur color patch edges and render outlines and objects less discernable. Each has beneficial features; however, each is disadvantageous in view of the present disclosure.

### BRIEF SUMMARY

Briefly described, in a preferred embodiment, the present disclosure overcomes the known disadvantages and meets the recognized need by providing a design architecture with an enhanced environmental interface that creates an illusion of multi-dimensionality, layers and texture.

According to its major aspects and broadly stated, in its preferred form, the present invention is a picture, or graphic design, that defines a new, hybrid pattern-class, and that is a representative formation of design pixels into a complex new type of digital pattern, preferably with at least three basic and functional layers, and with targeted enhancements for texture and dimensionality, wherein lighter colors “float” on top of the pattern while the dark colors “sink to the bottom” of the pattern below the main color layers.

More specifically, the device of the present invention in its preferred form is an Adaptive Disruptive Environmental Graphic Design (ADEGD) class pattern engineered to interact with the environment, and therefore is particularly useful as a camouflage. Computer generated shadowing and lighting techniques are coupled with known color contrasting and color scaling or fading techniques, wherein light and dark contrasting colors make up two of the three basic layers within the design architecture, with further enhancements for increase in depth perception within these contrast layers, and wherein a color scaling mid-adaptive layer is the third basic layer, serving to further enhance the environmental interface. Further design architecture features, preferably applied to all of the layers, create design static for increased disruptiveness and create the illusion of multi-dimensional texture.

A distinguishing and realistic quality of the ADEGD class pattern is that it is unidirectional, wherein a single orientation is preferred for best performance results. That is, lighting effects should be oriented toward the sky, or top of a user, and shadowing down toward the ground, or feet of the user, thus mimicking lighting effects natural in an environment. However, it is important to note that the ADEGD class pattern is not limited to a single image or pattern design, but may be used to make many successful patterns in this format, wherein any image or pattern design that may functionally interact with the environment as a result of shadow and/or lighting techniques, to highlight and increase depth perception, create texture, multi-dimensionality, disruptiveness, and to enhance overall performance of an environmentally based application or camouflage, is intended, by definition, to be an ADEGD class pattern.

A preferred naming convention for ADEGD class patterns is provided, wherein the pattern class is followed with reference characters defining environmental subdivisions for the particular design, the design date, and the design revision. The preferred formula is thus: ADEGD−(E)(D)·R. Environmental subdivision reference character “E” is preferably selected from (1) TF/T=temperate forest, (2) TR=tropical, (3) UR=urban, (4) DT/D=desert, (5) AQ=aquatic, or (6) AL=alpine/arctic. Design date reference character “D” is preferably formed from (1) year, and (2) month. Design revision reference character “R” is preferably formed from (1) number, and (2) version. Accordingly, the specific pattern that is representatively disclosed herein is for a temperate forest environment, bears a design date of July, 2010, and is a seventh revision of a version C. Therefore, the naming convention for the specific pattern is ADEGD-TF1007.7C

It is thus a feature and advantage of the present adaptive disruptive environmental graphic design class pattern that it is suitable for application of an identifiable naming convention.

It is also a feature and advantage of the present adaptive disruptive environmental graphic design class pattern that it uses computer generated shadowing and lighting techniques to interact with the environment and to foster the illusion of multi-dimensionality, layers and texture.

It is a further feature and advantage of the present adaptive disruptive environmental graphic design class pattern that it is a complex new type of digital pattern.

It is another feature and advantage of the present adaptive disruptive environmental graphic design class pattern that it has three basic layers, each with a specific function within the overall design architecture.

It is still another feature and advantage of the present adaptive disruptive environmental graphic design class pattern that it enhances known interface methods with lighting and shadowing effects to create texture.

It is yet another feature and advantage of the present adaptive disruptive environmental graphic design class pattern that, when viewed in a natural environment and perceived by an observer, the design edges appear to be lost and the lighting and shadowing effects of the layers create an extremely functional design relative to disruptiveness, concealment, and overall adaptability.

It is a further feature and advantage of the present adaptive disruptive environmental graphic design class pattern that it is unidirectional and three-dimensional.

It is still a further feature and advantage of the present adaptive disruptive environmental graphic design class pattern that lighter colors “float” on top of the pattern while the dark colors “sink to the bottom”.

It is yet still a further feature and advantage of the present adaptive disruptive environmental graphic design class pattern that organic rough texture causes the pattern to appear to cast shadows within itself.

These and other features and advantages of the invention will become more apparent to one skilled in the art from the following description and claims when read in light of the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present disclosure will be better understood by reading the Detailed Description of the Preferred and Alternate Embodiments with reference to the accompanying drawing figures, in which like reference numerals denote similar structure and refer to like elements throughout, and in which:

FIG. 1 is a color image of a specific ADEGD class pattern, according to the preferred embodiment of the present disclosure;

FIG. 2 is a grayscale image of a portion of the specific ADEGD class pattern of FIG. 1;

FIG. 3A is a grayscale image of a portion of an example light contrast layer of an ADEGD class pattern, according to the preferred embodiment of the present disclosure;

FIG. 3B is a grayscale image of a portion of an example dark contrast layer of an ADEGD class pattern, according to the preferred embodiment of the present disclosure;

FIG. 4 is a grayscale image of a portion of an example mid-adaptive layer of an ADEGD class pattern, according to the preferred embodiment of the present disclosure;

FIG. 5A is a digital photograph of a fabric imprinted with an ADEGD class pattern, according to the preferred embodiment of the present disclosure, showing a first selected segment of the pattern; and

FIG. 5B is a digital photograph of a fabric imprinted with an ADEGD class pattern, according to the preferred embodiment of the present disclosure, showing a second selected segment of the pattern.

### DETAILED DESCRIPTION OF THE PREFERRED AND ALTERNATE EMBODIMENTS

In describing the preferred and alternate embodiments of the present disclosure, as illustrated in the figures and/or described herein, specific terminology is employed for the sake of clarity. The disclosure, however, is not intended to be limited to the specific terminology so selected, and it is to be understood that each specific element includes all technical equivalents that operate in a similar manner to accomplish similar functions.

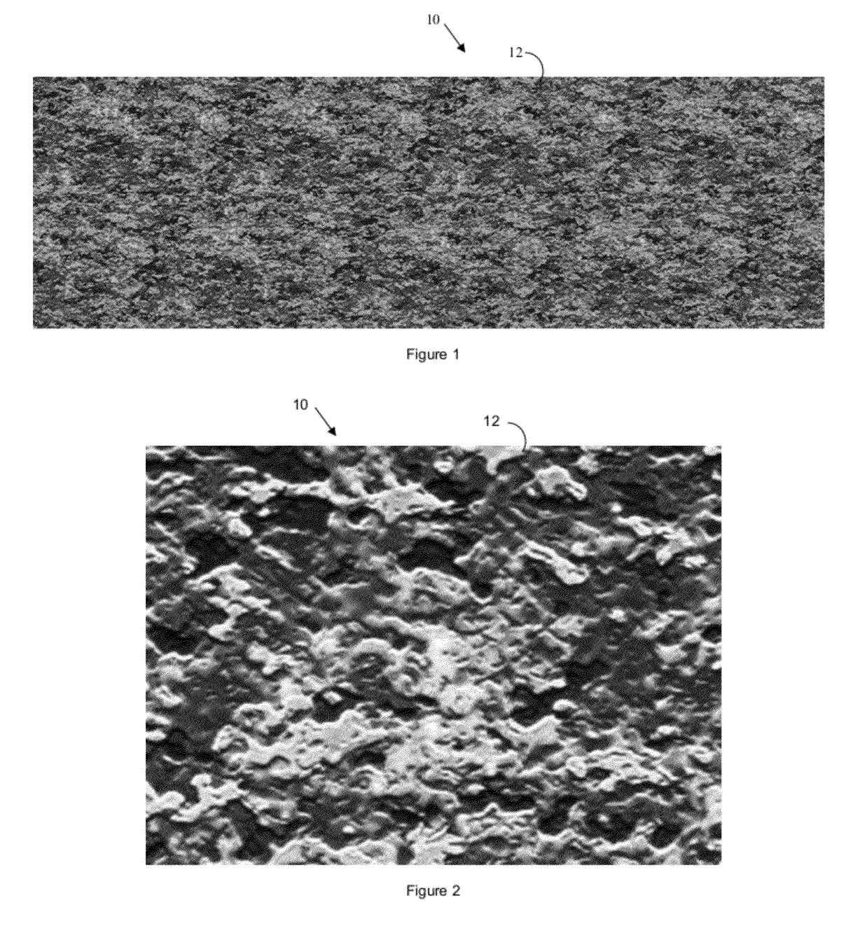

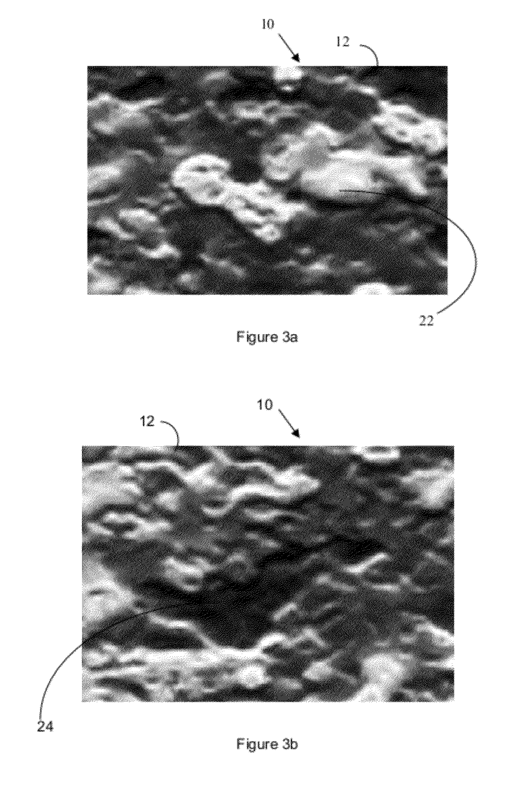

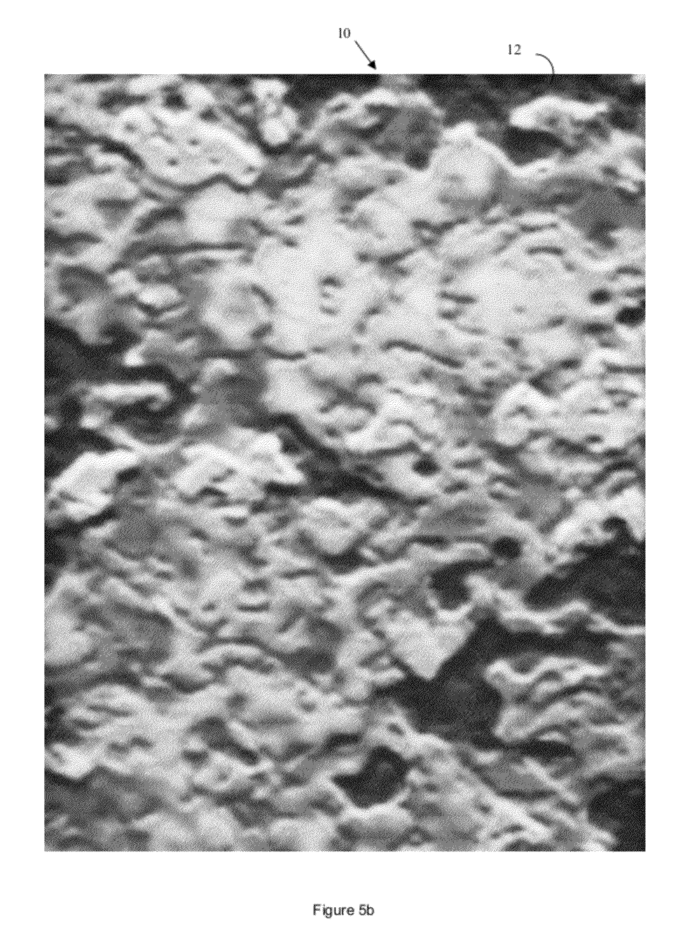

Referring now to FIGS. 1-5B, adaptive disruptive environmental graphic design ADEGD class pattern 10 preferably comprises picture or graphic design 12, engineered to interact with the environment using computer generated shadowing and lighting techniques to obtain the illusion of multi-dimensionality 44, layers 20, and texture 42 for the purpose of enhancing the environmental interface of the design architecture. AGEGD class pattern 10 is preferably a hybrid pattern, possessing traits found in known established patterns types, in its organic lines, yet defining a complex new type of digital pattern with its design pixels. Picture or graphic design 12 thus has some existing camouflaging techniques that are known to be effective incorporated therewithin, such as color contrasting to give the pattern depth. Color-scaling or fading colors are also utilized. Dramatic enhancement and improvement, however, is realized through the use of computer generated shadowing and lighting effects, wherein two illusions 40, namely texture 42 and multi-dimensionality 44, are created. These lighting and shadowing effects may be generated by such techniques, for example, as the use of computer graphical subroutines, or other appropriate techniques, without limitation, that are suitable for creation of the two preferred illusions 40, namely texture 42 and multi-dimensionality 44.

AGEGD class pattern 10 has a plurality of layers 20, with the preferred embodiment having at least three basic layers 20, wherein each layer 20 has a particular and specific function within the overall architecture of AGEGD class pattern 10, and wherein each layer 20 is preferably enhanced with shadowing and lighting effects. It should be noted, however, that more than three layers could be included, without departing from the intended scope of the present disclosure, as long as the layers 20 that are included are at least sufficient to accomplish the functions necessary to define AGEGD class pattern 10. In the preferred embodiment, light and dark contrasting colors make up two of three basic layers 20 within the design architecture: light contrast layer 22 (or Foreground) and dark contrast layer 24 (or Background).

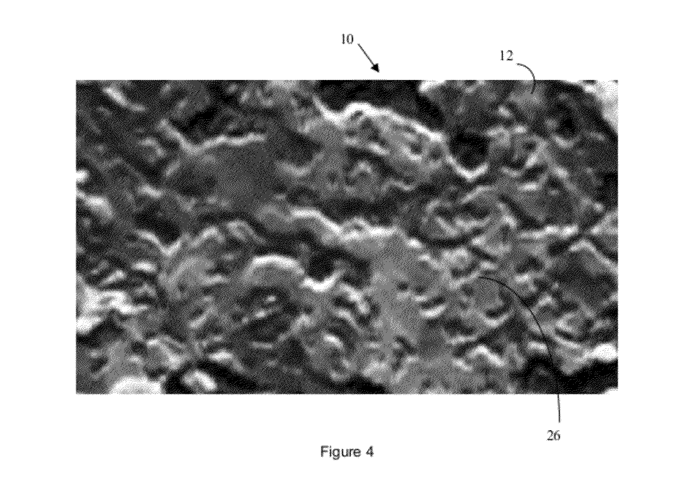

Light contrast layer 22 and dark contrast layer 24 are preferably defined by the intended use for AGEGD class pattern 10, wherein a typical and preferred formulation would be comprised of the lightest and darkest colors naturally found in the environmental application AGEGD class pattern 10 is designed to suit. Lighting and shadowing techniques are applied to further enhance and highlight these two contrast layers 22, 24, exaggerating the contrast in order to increase depth perception as well as to achieve the illusion of these layers 22, 24 floating forward and sinking back within the pattern architecture. A representative example of light contrast layer 22 is provided in FIG. 3A, and a representative example of dark contrast layer 24 is provided in FIG. 3B. As may be observed in the figures, these contrast layers 22, 24 are preferably randomly generated in both size and shape, and are typically (but not necessarily) smooth and organic in appearance and shape as found in nature.

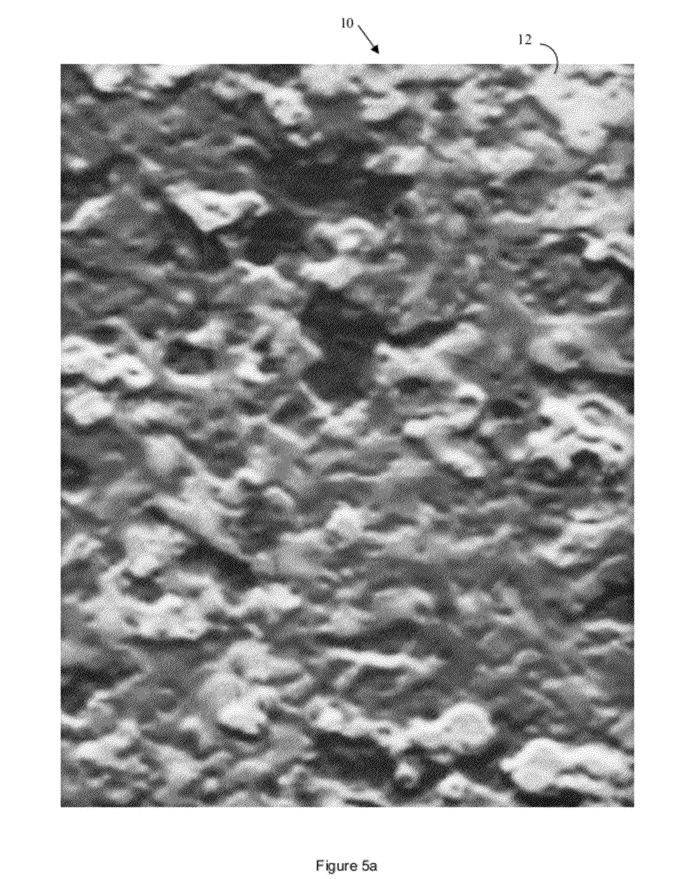

Preferably, mid-adaptive layer 26 makes up the third of the three basic layers 20 within the preferred design architecture. Mid-adaptive layer 26 preferably appears to be physically positioned between the two contrast layers 22, 24, and preferably contains all other needed colors naturally found in the intended environment, that is, those not otherwise contained in respective light and dark contrast layers 22, 24, but present in the ultimate use environment. As previously noted, AGEGD class pattern 10 uses color scaling, preferably within mid-adaptive layer 26 of picture or graphic design 12. The color scaling graphic technique effectively fades colors within mid-adaptive layer 26 into each other, allowing those colors to adapt to the brightness and hue of a similar background color to which picture or graphic design 12 is applied. Therefore, when viewed by a human eye, the appropriate color matching portion of the pallet-scaling becomes visually perceived as more dominant in appearance, according to the interface of picture or graphic design 12 with the environment. A representative example of mid-adaptive layer 26 is provided in FIG. 4.

In addition to plurality of layers 20, ADEGD class pattern 10 also preferably comprises shadowing and lighting effects, preferably randomly generated to create the appearance of “cracks” or texture 42 in picture or graphic design 12. The lighting and shadowing effects can be generated, for example but without limitation, by the use of computer graphical subroutines. The preferred perception of texture 42, by the human eye, is “rock-like”, wherein the purpose of this architecture feature is to create design static for increased disruptiveness, and also to create the illusion of multi-dimensional texture. Accordingly, when picture or graphic design 12 is viewed in a natural environment and perceived by an observer, the mind of the observer will seek to “make sense” of these textured lines and static, such that visual connections are made between picture or graphic design 12 and the surrounding environmental features. As a result, the blending and/or concealing ability of ADEGD class pattern 10 is dramatically increased due to this preferred feature, texture 42, wherein edges of picture or graphic design 12 appear to be lost as environmental connections are made by the observer's mind. This illusion, in combination with the lighting and shadowing effects found in contrast layers 22, 24 creates an extremely functional design in terms of disruptiveness, concealment, and overall adaptability when applied to an environment with a matching or otherwise coordinating design color pallet. For example, a color pallet equally divided of greens and tans interfaces with the environment such that the environmentally coordinating design color “pops” according to the surroundings. It is important to note that texture 42 of ADEGD class pattern 10 is distinctive in its functionality. That is, prior camouflage patterns seek to utilize texture effects to render some dimensionality. The advantageous improvement of ADEGD class pattern 10 relative to dimensionality is that real three-dimensional effects are accomplished, apart from texture 42 (which, as described, facilitates enhanced blending and/or concealing ability), through the use of lighting and shadowing.

ADEGD class pattern 10 is capable of such an environmentally functional performance that a distinguishing quality of the pattern is, unlike a majority of previously known camouflage patterns, ADEGD class pattern 10 is unidirectional. With lighting effects of picture or graphic design 12 oriented toward the sky, or top of a user, and with shadowing sloping down toward the ground or feet of the user, natural lighting effects of an environment are effectively mimicked. Therefore, ADEGD class pattern 10, and picture or graphic design 12, should only be oriented one way for best performance results, because it is the interface mechanism of ADEGD class pattern 10 that controls how the pattern 10 really works.

Specifically, it should be noted, therefore, that the use of the above described shadowing and/or lighting techniques to highlight and increase the perception of depth, and to create texture, multi-dimensionality, disruptiveness, or overall pattern/image/design performance-enhancement in an environmentally based application (as camouflage), has not been previously known, and the combination and application of the techniques enables creation of an end product pattern with tremendously improved features. If a particular pattern/image is observed and recognized as using shadowing and/or lighting techniques to accomplish the environmental interface functionality as described herein, then such a pattern/image is by definition an ADEGD class pattern/image. Because ADEGD class pattern 10 represents and entirely new format and new type of digital pattern, although exemplary pattern ADEGD-TF1007.7C is depicted in FIGS. 1, 2, 5a, and 5b, many other successful patterns may be created in the ADEGD class, with variation in color pallet, for example, wherein each pattern may be distinctive relative to another, and irregular as found in nature, with pixels capable of producing hundreds and hundreds of variations in color, but the functionality of each pattern's interaction with the environment will remain the same as all other patterns in the class.

In order to classify and reference an ADEGD pattern, a preferred naming convention is defined, wherein the pattern class is followed with reference characters defining environmental subdivisions for the particular design, the design date, and the design revision. The preferred formula is thus: ADEGD−(E)(D)·R. Environmental subdivision reference character “E” is preferably selected from (1) TF/T=temperate forest, (2) TR=tropical, (3) UR=urban, (4) DT/D=desert, (5) AQ=aquatic, or (6) AL=alpine/arctic. Design date reference character “D” is preferably formed from (1) year, and (2) month. Design revision reference character “R” is preferably formed from (1) number, and (2) version. Accordingly, the specific pattern that is representatively disclosed herein is for a temperate forest environment, bears a design date of July, 2010, and is a seventh revision of a version C. Therefore, the naming convention for the specific pattern is ADEGD-TF1007.7C.

Picture or graphic design 12 may be utilized for creation of camouflage apparel, wherein dye sublimation printing is preferred as a manner of transfer of picture or graphic design 12 to a substrate. Any desirable substrate, for example and without limitation, apparel fabric, tents, weapons, vehicles, netting, equipment, and/or tools may be adapted to receive ADEGD class pattern 10, according to any known and suitable technique for application of picture or graphic design 12 thereto. Unlike previously known digital camouflage patterns, ADEGD class pattern 10 is unidirectional, such that rotational printing or application is not necessitated for pattern variation, wherein ADEGD class pattern 10 is inherently random in form, yet organic and three-dimensional, according to pattern shadowing and lighting.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A class pattern, comprising:
an adaptive disruptive environmental graphic design, further comprising,
a plurality of computer generated shadowing and lighting elements;
a first visual illusion of multi-dimensionality;
a second visual illusion of texture; and
a third visual illusion of layers,
wherein said first, second and third visual illusions functionally interact with an environment to direct perception of an observer.

2. The class pattern of claim 1, further comprising a plurality of color contrasting and color scaling or color fading elements.

3. The class pattern of claim 1, wherein said adaptive disruptive environmental graphic design has a preferred orientation to facilitate said functional interaction with the environment.

4. A naming convention for said class pattern of claim 1, wherein said naming convention defines a pattern class, an environmental subdivision, a design date, and a design revision.

5. The naming convention of claim 3, wherein said environmental subdivision is selected from the group consisting of temperate forest, tropical, urban, desert, aquatic, or alpine/arctic.

6. A hybrid, graphic design pattern class, comprising:
a complex digital pattern formed by a plurality of design pixels and engineered to interact with the environment,
said complex digital pattern further comprising at least three functional layers.

7. The hybrid, graphic design pattern class of claim 6, said complex digital pattern further comprising a targeted enhancement for dimensionality that functionally directs an observer to perceive at least one light color floating proximate a surface of said complex digital pattern and to perceive at least one dark color below said surface.

8. The hybrid, graphic design pattern class of claim 6, said complex digital pattern further comprising targeted enhancement for texture.

9. The hybrid, graphic design pattern class of claim 6, wherein said complex digital pattern is a camouflage pattern.

10. The hybrid, graphic design pattern class of claim 6, further comprising a plurality of lighting effects and a plurality of shadowing effects, wherein said preferred orientation of said plurality of lighting effects is toward the top of a workpiece, and wherein said preferred orientation of said plurality of shadowing effects is toward the bottom of a workpiece.

11. The hybrid, graphic design pattern class of claim 6, wherein one of said at least three functional layers further comprises a plurality of light contrasting colors, and wherein another of said at least three functional layers further comprises a plurality of dark contrasting colors.

12. The hybrid, graphic design pattern class of claim 11, wherein a third of said at least three functional layers further comprises a color-scaling mid-adaptive layer.

13. The hybrid, graphic design pattern class of claim 6, wherein said at least three functional layers further comprise a plurality of architectural features that interact with the environment as design static and influence an observer to perceive increased pattern disruptiveness and multi-dimensional texture.

14. The hybrid, graphic design pattern class of claim 13, wherein said interaction of said complex digital pattern with the environment causes an observer in a natural environment to perceive shadows cast with said multi-dimensional texture of said pattern.

15. The hybrid, graphic design pattern class of claim 6, said complex digital pattern further comprising a plurality of design edges, wherein said interaction of said complex digital pattern with the environment causes an observer in a natural environment to perceive loss of said plurality of design edges.

16. The hybrid, graphic design pattern class of claim 6, wherein complex digital pattern has a preferred orientation to optimize said interaction with the environment.

17. The hybrid, graphic design pattern class of claim 6, wherein said complex digital pattern further comprises a picture.

18. A method of creating a camouflage pattern, comprising the steps of:
digitally creating a plurality of pattern layers; said plurality of pattern layers further comprising:
a foreground layer and a background layer, wherein said foreground layer is a light contrast layer, wherein said background layer is a dark contrast layer, and wherein said size and shape of said foreground layer and said background layer are randomly generated; and
a mid-adaptive layer, wherein said mid-adaptive layer is perceived to be positioned between said foreground layer and said background layer.

19. The method of creating a camouflage pattern of claim 17, further comprising the steps of:
defining an environmental application for said camouflage pattern;
identifying a lightest color in the environmental application and utilizing said lightest color in said foreground layer;
identifying a darkest color in the environmental application and utilizing said darkest color in said background layer;
identifying other necessary colors naturally found in the environmental application an utilizing said other necessary colors in said mid-adaptive layer.

20. The method of creating a camouflage pattern of claim 18, wherein said foreground layer and said background layer are smooth and organic in appearance and shape, and appear as found in the environmental application, and further comprising the steps of:
utilizing a color scaling graphic technique to fade said colors of said mid-adaptive layer; and
utilizing shadowing and lighting techniques to create the appearance of cracks or texture in said camouflage pattern.

21. The method of creating a camouflage pattern of claim 17, wherein said camouflage pattern created is unidirectional.
